(19) United States
(12) Patent Application Publication
(10) Pub. No.: US 2012/0181919 A1
(43) Pub. Date: Jul. 19, 2012

(54) Luminescent Ceramic Composite Converter and Method of Making the Same

(75) Inventor: George C. Wei, Weston, MA (US)

(73) Assignee: OSRAM SYLVANIA INC., Danvers, MA (US)

(21) Appl. No.: 12/199,440

(22) Filed: Aug. 27, 2008

(51) Int. Cl. H01J 1/63; C09K 11/64; C09K 11/59; C09K 11/78; B29D 11/00; C09K 11/66; C09K 11/80; C09K 11/84; H01J 9/22; C09K 11/08; C09K 11/67

(52) U.S. Cl. 313/503; 252/301.4 R; 252/301.4 F; 252/301.4 S; 445/58; 264/1.32

(57) ABSTRACT

A luminescent converter for a light emitting element (e.g., LED) includes a transparent, sol-gel-derived ceramic matrix having particles of at least one type of phosphor embedded therein that change a wavelength of the input light to light that has a different wavelength. The ceramic matrix is 20-80% porous with a majority of the pores having a diameter in a range of 2-20 nm. A method of making this converter includes preparing a sol-gel ceramic matrix embedded with the particles of phosphor in the matrix, and drying the matrix at no more than 600° C. to form the converter.

### BACKGROUND OF THE INVENTION

The present invention is directed to a converter for a light emitting element that converts a wavelength of light from the light emitting element (e.g., a blue light emitting diode) to a different wavelength (e.g., a yellow, red, or green light), and to method of making the converter.

Ceramic elements for converting a wavelength of light from a light source are known. See, for example, U.S. Patent Publication Nos. 2003/0025449, 2004/0145308 and 2007/0126017 and International Patent Publication No. WO 2006/097876. As described therein, a composite of phosphor particles is embedded in a ceramic or glass matrix; for example cerium-activated yttrium aluminum garnet (YAG:Ce) phosphor particles embedded in polycrystalline alumina. The latter document notes that porosity of the finished composite matrix is at most about 1%. The color of the converted light is adjusted by changing the mix of the phosphor particles in the matrix.

A sol-gel process is a known wet-chemical technique that can be used to make a metal oxide starting from either a chemical solution or colloidal particles (a sol) to produce an integrated network (a gel). A precursor, such as a metal alkoxide or metal chloride, undergoes hydrolysis and polycondensation reactions and then evolves to form an inorganic continuous network containing a liquid phase (the gel). Removal of the liquid in the wet gel under certain conditions results in a porous, low density material. For example, a transparent, porous, sol-gel alumina is known. See, e.g., Yoldas, A Transparent Porous Alumina, Ceramic Bulletin, 54(3), 286-288, (1975).

### SUMMARY OF THE INVENTION

An object of the present invention is to provide a novel luminescent converter for a light emitting element.

A further object of the present invention is to provide a novel method of making this luminescent converter that uses a sol-gel process with a low temperature drying step to avoid damage to the embedded phosphor particles.

A yet further object of the present invention is to provide a novel a luminescent converter that includes a transparent, sol-gel-derived ceramic matrix having at least one type of phosphor embedded therein that changes a wavelength of the input light to light that has a different wavelength, where the ceramic matrix is 20-80% porous with a majority of the pores having a diameter in a range of 2-20 nm, and in particular, 2-10 nm. More preferably, the ceramic matrix is 40-60% porous.

Another object of the present invention is to provide a novel method of making this converter that includes the steps of preparing a sol-gel ceramic matrix embedded with at least one type of phosphor in the matrix, and drying the matrix at no more than about 600° C., preferably less than 500° C., and in some embodiments less than 175° C., to form the converter.

These and other objects and advantages of the invention will be apparent to those of skill in the art of the present invention after consideration of the following drawings and description of preferred embodiments.

### BRIEF DESCRIPTION OF THE DRAWINGS

FIG. 1 is a schematic representation of a cross-section of a converter of the present invention on a light emitting element.

FIG. 2 is a graphical illustration of the spectra from a blue LED and a blue LED with the luminescent ceramic composite converter.

### DETAILED DESCRIPTION OF THE INVENTION

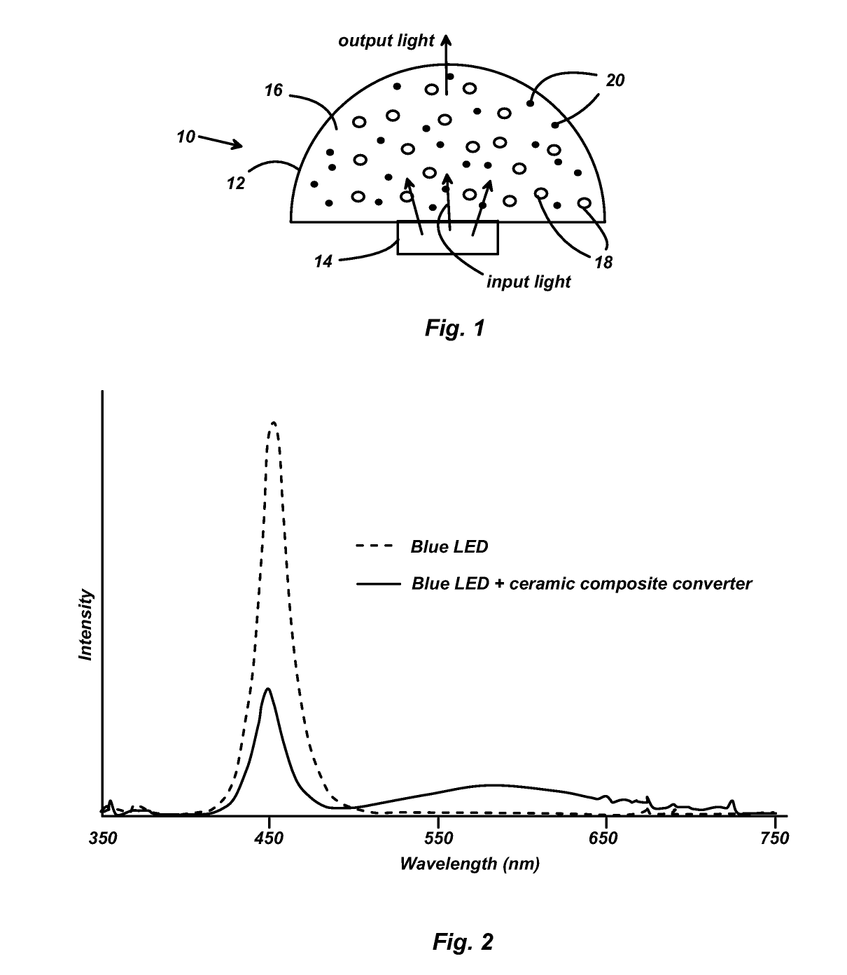

With reference now to FIG. 1, a luminescent converter 10 for a light emitting element includes in a preferred embodiment a lens 12 that receives input light at a bottom surface and outputs light from a top surface in a predetermined direction. The input light may be provided by a light emitting element 14, such as a light emitting diode that emits light of a particular color (e.g., blue). The lens 12 is a transparent, sol-gel-derived ceramic matrix 16 having particles of at least one type of phosphor 18 embedded therein that change a wavelength of the input light to light that has a different wavelength (e.g., blue to yellow, green or red). Preferably, the input light is blue light from a blue-emitting LED and the phosphor particles are YAG:Ce phosphor particles that convert at least a portion of the blue light to a yellow light which when combined with the unconverted blue light results in an overall output light that appears white. Phosphor particles of other types of phosphors may be added to improve color rendering, e.g., particles of a red-emitting phosphor. Such other phosphors may include Sr₅Al₂O₇S:Eu²⁺, (Ca,Sr)S:Eu, (Ca,Sr)S:Ce³⁺, Ca₂Si₅N₈:Eu²⁺, (Ca,Sr,Ba)₂Si₅N₈:Eu²⁺, Ba₂Si₅N₈:Eu²⁺, BaSi₇N₁₀:Eu²⁺, CaAlSiN₃:Eu²⁺, CaSiN₂:Ce³⁺, SrSi₂O₂₋ₓN_{2+2/3x}:Eu²⁺ (or Ce³⁺), (Sr,Ba, Ca)Si₂O₂N₂:Eu²⁺, Ca-α-SiAlON:Eu²⁺(Ca_{m/2}Si₁₂₋ₘ₋ₙAlₘ₊ₙOₙNi₁₆₋ₙ:Eu²⁺) or other SiAlON-family phosphors (including (Sr,Ba, Ca)—SiAlON:Eu²⁺ and (Lu,Y)—SiAlON:Ce³⁺,Pr³⁺); and other phosphor types such as (Sr,Ba,Mg)₂SiO₄:Eu²⁺(Sr,Ba)₃SiO₅:Eu²⁺, Y₂O₃:Eu,Bi, vanadate garnet (Ca₂NaMg₂V₃O₁₂:Eu³⁺), alkaline earth metal thiogallate (MGa₂S₄:Eu²⁺), and Ca₈Mg(SiO₄)₄Cl₂:Eu²⁺.

The ceramic matrix of the luminescent converter is 20-80% porous with a majority of the pores (schematically shown as dots 20 in FIG. 1) having a diameter in a range of 2-20 nm, preferably 2-10 nm. The pores of this size do not significantly scatter or absorb visible light. The pores decrease thermal conductivity of the ceramic matrix compared to that of a denser body. However, the porous nature of the matrix permits better bonding to the light emitting element. Although the luminescent converter in preferred embodiment shown in FIG. 1 has a lens shape, the shape of the converter is not limited to an optically active shape and may simply be a flat plate placed on top of the light emitting element. Transparency as used herein is generally defined to mean that a human observer would be able to read with an unaided eye alphanumeric characters printed on a paper that has been placed beneath the sol-gel body. For example, the bodies shown in FIG. 1 of Yoldas, A Transparent Porous Alumina, Ceramic Bulletin, 54(3), 286-288 (1975), are transparent.

The ceramic matrix 16 is preferably alumina, but also may be silica, yttria, zirconia, hafnia, or indium tin oxide (ITO). The pores 20 may be filled with one of air, oxygen, and helium. The ITO matrix and pores filed with air or oxygen may be used to provide an electrically conducting matrix, if needed. The helium filled pores may be used to increase the thermal conductivity. Preferably, the ceramic matrix contains particles of plural different types of phosphors 18 that may include YAG:Ce phosphor particles and at least one of nitride, sulfide, oxynitride and oxysulfide phosphors. Other phosphors may also be used, depending on the color of the output light. The plural different types of phosphors may be embedded homogeneously throughout the ceramic matrix, or may be unevenly distributed to provide a particular color effect.

The porous ceramic matrix 16 is made with a sol-gel process in which the shaped ceramic is dried at a low temperature, preferably less than 600° C., more preferably less than 500° C., and in some embodiments less than 175° C.

The method of making the converter 10 for a light emitting element may include the steps of forming a sol-gel ceramic matrix 16 embedded with at least one type of phosphor particles 18 in the matrix where, preferably, the phosphors are selected to change a wavelength of input light so that the overall output light from the converter is a white light, and drying the phosphor-embedded, sol-gel matrix at no more than about 600° C. to form a converter that is preferably 20-80% porous with a majority of the pores 20 having a diameter in a range of 2-20 nm.

An example of the light converting element comprising a sol-gel alumina and a YAG:Ce phosphor was made by adding 12 cc de-ionized water to 1 g of YAG:Ce and 4.1 g Catapal B (boehmite) or Dispal 23N4-80 (alumina hydroxide oxide); stirring for three minutes; adding 1 cc of 50% HNO₃ acid to age and gel at room temperature for six hours; and drying in an oven at 90° C. for 16 hours. The sol-gel composite was placed on a blue-light LED and yielded 31 lumens of a white light compared to 45 lumens of white light produced by a monolithic, sintered YAG:0.5% Ce ceramic converter.

A second example was made by adding 12 cc of 20 wt % alumina sol (50 nm) (Nyacol AL-20) to 0.6 g of YAG:4% Ce and 0.3 g of Ca₂Si₅N₈:Eu²⁺; stifling for three minutes; adding 0.2 cc of 30% NH₄NO₃ to age and gel at room temperature for six hours; and drying in an oven at 90° C. for 16 hours and then at 175° C. for 16 h. The sol-gel composite having a thickness of about 0.1 mm thick was placed on a blue LED and produced 144 lumens per watt of a white light (x=0.2904, y=0.2147) whose spectrum is shown in FIG. 2.

A third example was made by adding 20 cc of 20 wt % ZrO₂ (Y₂O₃-doped) sol (100 nm) (Nyacol DRYS4-20) to 1.12 g of YAG:4% Ce; stifling for three minutes; adding 0.4 cc of 30% NH₄NO₃ to age and gel at room temperature for six hours; and drying in an oven at 90° C. for 16 hours and then at 175° C. for 16 h.

A fourth example was made by adding 12 cc of 30 wt % silica sol (20 nm) (Nyacol DP5820) to 1.2 g of YAG:4% Ce and 0.5 g of Ca₂Si₅N₈:Eu²⁺; stirring for three minutes; adding 0.2 cc of 30% NH₄NO₃ to age; exchanging with ethanol at room temperature; and drying in an oven at 90° C. for 16 hours and then at 175° C. for 16 h.

The drying step may involve removing liquid from the sol-gel under a supercritical condition. This helps reduce shrinkage to a negligible level and provides a reasonable surface finish so that surface grinding and polishing can be reduced or eliminated.

Further, the phosphor-embedded sol-gel ceramic matrix 16, 18 may be placed directly on the light emitting element (no adhesive necessary), where the drying step occurs with the matrix directly on the light emitting element 14. That is, the sols can be cast directly on an LED die, followed by drying at less than 175° C., a temperature that is tolerated by the die. This forms a direct bond between the converter body and the die and improves the refractive index match with the die without the need for the commonly used silicone resin glue. In addition, the phosphor-embedded, sol-gel matrix may be readily shaped into an optically active shape such as the lens shown in FIG. 1.

The low temperature processing of the present invention affords a particular advantage in that the phase stability of certain phosphors is maintained. For example, a number of the red-emitting LED phosphors suffer significant brightness loss or even decompose at the higher temperatures need to form sintered ceramics.

The low temperature processing also allows impure YAG:Ce to be used. Commercial YAG:Ce typically contains small amounts (0.01-1 wt %) of unreacted impurities such as Y₂O₃, alumina, perovskite, monoclinic, and Ce aluminate that can cause problems for high temperature (>1700° C.) sintered transparent YAG:Ce ceramics. This problem does not arise with the lower temperatures of the present invention.

If the phosphors are nano-sized (less than about 200 nm), the entire sol-gel composite may be transparent.

While embodiments of the present invention have been described in the foregoing specification and drawing, it is to be understood that the present invention is defined by the following claims when read in light of the specification and drawing.

I claim:

1. A luminescent converter for a light emitting element, comprising:
a transparent, sol-gel-derived ceramic matrix having particles of at least one type of phosphor embedded therein that changes a wavelength of input light from the light emitting element to light that has a different wavelength, said ceramic matrix being 20-80% porous with a majority of the pores having a diameter in a range of 2-20 nm.

2. The converter of claim 1, wherein said ceramic matrix comprises one of alumina, silica, yttria, zirconia, and hafnia.

3. The converter of claim 1 in combination with the light emitting element, wherein said converter is bonded directly to the light emitting element.

4. The converter of claim 1, wherein said ceramic matrix comprises indium tin oxide (ITO).

5. The converter of claim 1, wherein said pores are filled with one of helium, air, and oxygen.

6. The converter of claim 1, wherein said matrix has plural different types of phosphors comprising YAG:Ce phosphor particles and particles of at least one of nitride, sulfide, oxynitride and oxysulfide phosphors.

7. The converter of claim 6, wherein said plural different types of phosphors are embedded homogeneously throughout said ceramic matrix.

8. The converter of claim 1, wherein the majority of said pores have a diameter in a range of 2-10 nm.

9. The converter of claim 1, wherein said converter is a lens that receives the input light at a bottom surface and outputs light from a dome-shaped top surface.

10. The converter of claim 1, wherein said ceramic matrix is 40-60% porous.

11. The converter of claim 10, wherein said ceramic matrix comprises one of alumina, silica, yttria, zirconia, and hafnia.

12. A method of making a luminescent converter for a light emitting element, comprising the steps of:
forming a sol-gel ceramic matrix embedded with particles of at least one type of phosphor; and
drying the sol-gel matrix at no more than 600° C. to form the luminescent converter wherein the converter is 20-80% porous with a majority of the pores having a diameter in a range of 2-20 nm.

13. The method of claim 12, wherein the drying step removes liquid under a supercritical condition.

14. The method of claim 12, further comprising the step of placing the phosphor-embedded sol-gel ceramic matrix directly on a light emitting element, and wherein the drying step occurs with the matrix directly on the light emitting element and at a temperature of less than 175° C.

15. The method of claim 12, wherein said ceramic matrix comprises one of alumina, silica, yttria, zirconia, and hafnia.

16. The method of claim 12, wherein said ceramic matrix comprises indium tin oxide (ITO).

17. The method of claim 12, wherein the matrix is embedded with plural different types of phosphors comprising YAG:Ce phosphor particles and particles of at least one of nitride, sulfide, oxynitride and oxysulfide phosphors.

18. The method of claim 17, further comprising the step of embedding the plural different types of phosphors homogeneously throughout the ceramic matrix.

19. The method of claim 12, wherein the majority of said pores have a diameter in a range of 2-10 nm and said ceramic matrix is 40-60% porous.

20. The method of claim 12 wherein the sol-gel matrix is formed into a lens shape prior to drying.
